(19) United States
(12) Patent Application Publication
(10) Pub. No.: US 2015/0022878 A1
(43) Pub. Date: Jan. 22, 2015

(54) OPTICAL FILM HAVING EXCELLANT UV BLOCKING EFFECT AND POLARIZING PLATE COMPRISING THE SAME

(71) Applicant: LG CHEM, LTD., Seoul (KR)

(72) Inventors: Suk-Il Youn, Daejeon (KR); Sang-Min Kwak, Daejeon (KR); Jun-Geun Um, Daejeon (KR); Sei-Jung Park, Daejeon (KR); Nam-Jeong Lee, Daejeon (KR); Joon-Hoon Lee, Daejeon (KR)

(21) Appl. No.: 14/359,686

(22) PCT Filed: Feb. 21, 2014
(86) PCT No.: PCT/KR2014/001415

§ 371 Date: May 21, 2014

(30) Foreign Application Priority Data
Feb. 21, 2013 (KR) 10-2013-0018781

(51) Int. Cl. G02B 5/20; G02B 5/30

(52) U.S. Cl. CPC G02B 5/208; G02B 5/3091
USPC 359/352; 359/361

(57) ABSTRACT

An optical film and a polarizing plate including the same are provided. The optical film includes an acrylic resin having a glass transition temperature of 120° C. or higher and including an alkyl (meth)acrylate-based repeating unit and a styrene-based repeating unit, and a UV absorbent having a 1% thermal decomposition temperature greater than or equal to a temperature 2.5 times that of the glass transition temperature of the acrylic resin.

### TECHNICAL FIELD

The present invention relates to an optical film and a polarizing plate including the same, and, more particularly, to an acrylic optical film having an excellent UV blocking effect and a polarizing plate including the same.

### BACKGROUND ART

In recent years, a triacetyl cellulose film (hereinafter referred to as “TAC film”), generally serving as a protective film configured to protect polyvinyl alcohol polarizers, has been widely used as a polarizing plate in image display devices such as Liquid Crystal Display (LCD) devices. However, such a TAC film may be problematic in that the characteristics of the polarizing plate such as polarization degree or color may be degraded by film deformation when the TAC film is used under conditions of high temperature or high humidity since it has poor heat and humidity resistance. Therefore, an alternative method using a transparent acrylic resin film having excellent heat and humidity resistance instead of the TAC film as a material of the protective film of the polarizer is currently being proposed.

Techniques of preventing degradation of polarizers by UV rays by adding a UV absorbent to such an acrylic film to exhibit UV absorption ability have also been proposed. In the case of such a conventional acrylic film, it was reported that a benzotriazol-based or benzophenone-based compound, a cyanoacrylate-based compound, a salicylic acid-based compound and the like could be used as a UV absorbent. However, the above-described UV absorbents have problems in that UV absorption ability may be degraded and a resin and a film may be yellowed since most thereof are cracked when processed at a high temperature. Further, when UV absorbents are added to an acrylic resin, a significant decrease in glass transition temperature of the resin composition may degrade heat resistance of the resin composition, or may have a negative effect on optical properties of an optical film, compared to the resin composition before the UV absorbents are added to the acrylic resin.

### DISCLOSURE

### Technical Problem

The present invention is designed to solve the problems of the prior art, and therefore an object of the present invention is to provide an acrylic optical film capable of effectively blocking UV rays without having a negative effect on physical properties of an optical film, and a polarizing plate including the same.

### Technical Solution

To solve the above problems, one aspect of the present invention provides an optical film including an acrylic resin having a glass transition temperature of 120° C. or higher and comprising an alkyl (meth)acrylate-based repeating unit and a styrene-based repeating unit, and a UV absorbent having a 1% thermal decomposition temperature greater than or equal to a temperature 2.5 times that of the glass transition temperature of the acrylic resin.

In this case, the UV absorbent may be included in a content of 0.1 to 5 parts by weight, based on 100 parts by weight of the acrylic resin.

Also, the UV absorbent may be a triazine-based UV absorbent, and may have a 1% thermal decomposition temperature of 300° C. to 400° C.

In addition, the optical film according to the present invention may have optical transmittance at a wavelength of 380 nm of 5% or less, as measured after conversion into a thickness of 40 μm, and a variation in a b value of the optical film may be less than or equal to 0.5.

Another aspect of the present invention provides a polarizing plate including at least one optical film according to the present invention.

### Advantageous Effects

Since a UV absorbent having a high 1% thermal decomposition temperature is used in the optical film according to the present invention, the UV absorbent is hardly thermally cracked even in a process of pelletizing a resin, or a high-temperature process such as film elongation or the like. As a result, the optical film according to the present invention can be useful in effectively inhibiting yellowing caused during thermal cracking of the UV absorbent and maintaining high transparency of films.

Also, the optical film according to the present invention can be useful in exhibiting an excellent UV blocking effect, and also exhibiting high optical transmittance in a visual wavelength range and excellent heat resistance as well.

### BEST MODE

Hereinafter, preferred embodiments of the present invention will be described in detail.

The present inventors have conducted research to develop an optical film having an excellent UV blocking effect and simultaneously exhibiting excellent physical properties such as transparency, color and durability, and developed an optical film according to the present invention.

The optical film according to the present invention includes (1) an acrylic resin having a glass transition temperature of 120° C. or higher and including an alkyl (meth)acrylate-based repeating unit and a styrene-based repeating unit, and (2) a UV absorbent having a 1% thermal decomposition temperature greater than or equal to a temperature 2.5 times that of the glass transition temperature of the acrylic resin.

In the optical film according to the present invention, an acrylic resin having a glass transition temperature of 120° C. or higher, preferably 120° C. to 200° C., and more preferably 120° C. to 140° C. may be used as a base material. When the glass transition temperature of the acrylic resin is less than 120° C., heat resistance of a film may be deteriorated, and thus the polarizing plate may be bent after lamination of the polarizing plate, or durability of the polarizing plate may be deteriorated.

According to the present invention, the acrylic resin may be a copolymeric resin including an alkyl (meth) acrylate-based repeating unit and a styrene-based repeating unit.

In this case, the alkyl (meth)acrylate refers to a component including all types of alkyl acrylates and alkyl methacrylates, but the present invention is not limited thereto. In consideration of optical transparency, compatibility, processability and productivity, an alkyl group of the alkyl (meth)acrylate preferably has approximately 1 to 10 carbon atoms, and more preferably 1 to 4 carbon atoms, and a methyl group or an ethyl group is most preferred. For example, the alkyl (meth)acrylate may be methyl acrylate, ethyl acrylate, methyl methacrylate, ethyl methacrylate, or the like. Among these, the methyl methacrylate is especially preferred. Meanwhile, the alkyl (meth)acrylate repeating unit may be present in a content of approximately 50 to 99.9 parts by weight, preferably approximately 70 to 99 parts by weight, and more preferably approximately 97 to 99.9 parts by weight, based on 100 parts by weight of the copolymeric resin. When the content of the alkyl (meth)acrylate repeating unit is in this content range, the optical film according to the present invention may exhibit excellent phase difference properties and optical properties.

Meanwhile, the styrene-based repeating unit refers to a repeating unit derived from a substituted or unsubstituted styrene monomer. For example, the styrene-based repeating unit may be a repeating unit derived from α-methyl styrene, p-methyl methacrylate, vinyl toluene, t-butyl styrene, or the like. Among these, the α-methyl styrene is especially preferred. The styrene-based repeating unit may be present in a content of approximately 0.1 to 10 parts by weight, preferably approximately 0.1 to 5 parts by weight, and more preferably approximately 0.1 to 3 parts by weight, based on 100 parts by weight of the copolymeric resin. When the content of the styrene-based repeating unit is in this content range, the optical film according to the present invention may exhibit excellent phase difference properties and optical properties.

Meanwhile, the acrylic resin may further include an imide-based repeating unit, a vinyl cyanide-based repeating unit, a 3- to 6-membered heterocyclic unit containing a functional group substituted with at least one carbonyl group, and/or a (meth)acrylate-based repeating unit having an aromatic ring in order to improve heat resistance, as necessary.

Specific examples of the imide-based repeating unit may include repeating units derived from maleimides, for example, a maleimide containing a functional group substituted with an alkyl group having 1 to 10 carbon atoms, a maleimide containing a functional group substituted with an alkyl group having 6 to 12 carbon atoms. More particularly, the imide-based repeating unit may be a repeating unit derived from cyclohexyl maleimide, phenyl maleimide, or the like. The imide-based repeating unit may be present in a content of approximately 1 to 30 parts by weight, preferably approximately 5 to 20 parts by weight, and more preferably approximately 8 to 15 parts by weight, based on 100 parts by weight of the copolymeric resin.

For example, the vinyl cyanide-based repeating unit may include repeating units derived from acrylonitrile. The vinyl cyanide-based repeating unit may be present in a content of approximately 1 to 30 parts by weight, preferably approximately 5 to 20 parts by weight, and more preferably approximately 8 to 15 parts by weight, based on 100 parts by weight of the copolymeric resin.

For example, the (meth)acrylate-based repeating unit having an aromatic ring may include repeating units derived from a (meth)acrylate containing an aromatic ring having 6 to 12 carbon atoms, and, more particularly, repeating units derived from phenyl (meth)acrylate, benzyl (meth)acrylate, and the like. The (meth)acrylate-based repeating unit having an aromatic ring may be present in a content of approximately 1 to 50 parts by weight, preferably approximately 5 to 30 parts by weight, and more preferably approximately 5 to 10 parts by weight, based on 100 parts by weight of the acrylic resin.

Meanwhile, specific examples of the 3- to 6-membered heterocyclic repeating unit containing a functional group substituted with at least one carbonyl group may include a lactone ring unit. The 3- to 6-membered heterocyclic repeating unit containing a functional group substituted with at least one carbonyl group may be present in a content of approximately 10 to 50 parts by weight, preferably approximately 20 to 40 parts by weight, and more preferably approximately 25 to 35 parts by weight, based on 100 parts by weight of the copolymeric resin.

Meanwhile, the acrylic resin according to the present invention may be a compounding resin in which another resin is blended with the copolymeric resin including the above-described repeating units. An aromatic resin having a carbonate residue at the main chain and the like may be, for example, used as the resin that may be blended with the acrylic resin according to the present invention. In this case, the aromatic resin having a carbonate residue at the main chain may be a polycarbonate-based resin, and the acrylic resin and the aromatic resin having a carbonate residue at the main chain may be mixed at a weight ratio of 0.1:100 to 10:100, preferably a weight ratio of 0.5:100 to 8:100, and more preferably a weight ratio of 1:100 to 5:100.

Meanwhile, the UV absorbent may have a 1% thermal decomposition temperature greater than or equal to a temperature approximately 2.5 times, preferably in a range of approximately 2.5 to 5.0 times, and more preferably in a range of approximately 2.5 to 3.0 times that of the glass transition temperature of the acrylic resin used as a base material. When the 1% thermal decomposition temperature of the UV absorbent is less than the glass transition temperature of the acrylic resin by a factor of approximately 2.5, a casting roll may be contaminated with a migration state in which the UV absorbent exudes from the optical film during film processing.

More preferably, the 1% thermal decomposition temperature of the UV absorbent may be in a range of approximately 300° C. to 400° C. Most preferably, the 1% thermal decomposition temperature of the UV absorbent may be in this temperature range in consideration of fouling resistance, optical properties, and the like. According to the present invention, the 1% thermal decomposition temperature of the UV absorbent refers to a temperature measured using TGA equipment (commercially available from TA) when the weight of the UV absorbent decreases by 1%, compared to the initial weight of the UV absorbent, while heating the UV absorbent at a rate of 10° C. per minute under a nitrogen atmosphere.

The UV absorbent having the above-described characteristics may, for example, include a triazine-based UV absorbent, but the present invention is not limited thereto. The triazine-based UV absorbent that may be used herein may include Tinuvin 460 (commercially available from BASF), LA F70 (commercially available from ADEKA), and the like.

Meanwhile, the UV absorbent may be present in a content of approximately 0.1 to 5 parts by weight, and more preferably, approximately 0.1 to 4 parts by weight, based on 100 parts by weight of the acrylic resin. When the content of the UV absorbent satisfies this content range, the optical film may exhibit both excellent optical properties and UV blocking effect.

Meanwhile, a method of manufacturing the above-described optical film according to the present invention is not particularly limited. For example, the optical film may be manufactured by thoroughly mixing an acrylic resin with a UV absorbent and other additives such as a polymerizing agent using any suitable mixing method to prepare a thermoplastic resin composition and molding the thermoplastic resin composition into films.

The thermoplastic resin composition may, for example, be prepared by pre-blending film components using any suitable mixing machine such as an Omni mixer and extruding and kneading the resulting mixture. The mixing machine used for the extrusion and kneading is not particularly limited. For example, any suitable mixing machine such as a single-screw extruder or a double-screw extruder, or a dispersion kneader may be used herein.

Meanwhile, the film molding may, for example, be performed using any suitable film molding methods known in the related art, such as solution casting method (i.e., a solution softening method), a melt extrusion method, a calendar method, an extrusion molding method, and the like. Among these, the solution casting method or the melt extrusion method is preferred.

A solvent used in the solution casting method may, for example, include aromatic hydrocarbons such as benzene, toluene, and xylene; aliphatic hydrocarbons such as cyclohexane, and decaline; esters such as ethyl acetate, and butyl acetate; ketones such as acetone, methyl ethyl ketone, and methylisobutylketone; alcohols such as methanol, ethanol, isopropanol, butanol, isobutanol, methyl cellosolve, ethyl cellosolve, and butyl cellosolve; ethers such as tetrahydrofuran, and dioxane; halogenated hydrocarbons such as dichloromethane, chloroform, and carbon tetrachloride; dimethylformamide; dimethylsulfoxide, and the like. Here, the above-described solvents may be used alone or in combination of two or more.

An apparatus for performing the solution casting method may, for example, include a drum-type casting machine, a band-type casting machine, a spin coater, and the like. The molding temperature is preferably in a range of 150 to 350° C., and more preferably in a range of 200 to 300° C.

Meanwhile, the melt extrusion method may, for example, include a T-die method, an inflation method, and the like. When a film is molded using the T-die method, a roll-shaped film may be obtained by installing a T-die at a leading end of a known single-screw or double-screw extruder and winding a film extruded in the form of a thin film. In this case, uniaxial elongation may be performed by properly adjusting the temperature of a winding roll and elongating the film in an extrusion direction. Also, simultaneous and sequential biaxial elongations may be performed by elongating the film in a direction perpendicular to the extrusion direction.

The optical film according to the present invention may be either a non-elongated film or an elongated film. In this case, the elongated film may be either a uniaxially elongated film or a biaxially elongated film, and the biaxially elongated film may be either a simultaneously biaxially elongated film or a sequentially biaxially elongated film. When the film is biaxially elongated, the performance of the film may be improved due to improved mechanical strength. Meanwhile, when another thermoplastic resin is blended with the acrylic resin and used, the acrylic resin may maintain optical isotropy by suppressing an increase in phase difference by elongation.

Meanwhile, when it is assumed that the glass transition temperature of the resin composition is Tg, the elongation may be performed at a temperature ranging from (Tg−30)° C. to (Tg+100)° C., more preferably (Tg−20)° C. to (Tg+80)° C. When the elongation temperature is less than (Tg−30)° C., sufficient elongation magnification may not be obtained, whereas stable elongation may not be achieved due to the flowing of the resin composition when the elongation temperature exceeds (Tg+100)° C.

Meanwhile, when the elongation magnification is defined as an area ratio, the elongation magnification may preferably be in a range of approximately 1.1 to 25 times, and more preferably in a range of approximately 1.3 to 10 times. When the elongation magnification falls in this numerical range, excellent physical properties, such as toughness, may be achieved.

The elongation rate in one direction is preferably in a range of 10 to 20,000%/min, and more preferably in a range of 100 to 10,000%/min. When the elongation rate is less than 10%/min, a time required to reach sufficient elongation magnification may be lengthened, which lead to poor productivity. On the other hand, when the elongation rate exceeds 20,000%/min, the elongated film may be broken.

Meanwhile, the optical film according to the present invention may be subjected to thermal treatment (annealing) after the elongation as described above in order to stabilize the optical isotropy or mechanical characteristics. The thermal treatment conditions are not particularly limited, but may be properly adjusted according to desired physical properties.

The optical film of the present invention prepared by the above-described method has optical transmittance at a wavelength of 380 nm of 5% or less, as measured after conversion into a thickness of 40 μm, indicating that the optical film of the present invention has an excellent UV blocking effect.

Also, the optical film of the present invention has a variation in a b value of 0.5 or less, compared to an optical film which does not include the UV absorbent, indicating that the optical film of the present invention exhibits an excellent color sense.

In addition, the optical film of the present invention has optical transmittance of 92% or more in a visual wavelength range, indicating that the optical film of the present invention exhibits excellent optical properties.

The optical film according to the present invention may be effectively used as a protective film configured to protect a polarizing plate when the optical film(s) is attached to one surface or both surfaces of the polarizer. In this case, attachment of the optical film of the present invention to the polarizer may be performed using a method of coating a surface of a film or a polarizer with an adhesive using a roll coater, a gravure coater, a bar coater, a knife coater or a capillary coater, followed by thermally laminating the polarizer with a protective film in a lamination roll or laminating the polarizer with a protective film at room temperature by compression. Meanwhile, adhesives used in the relate art, for example, polyvinyl alcohol-based adhesives, polyurethane-based adhesives, acrylic adhesives, and the like may be used as the adhesive without limitation.

Furthermore, the optical film according to the present invention is applicable to various display devices such as liquid crystal display devices, plasma display devices, electroluminescent devices, and the like.

### MODE FOR INVENTION

Hereinafter, preferred exemplary embodiments of the present invention will be described in order to aid in understanding the present invention. However, it should be understood that the description set forth herein is merely exemplary and illustrative of exemplary embodiments for the purpose of describing the present invention, and is not intended to limit the present invention.

<Measurement Method>

The 1% thermal decomposition temperature was measured using TGA equipment (commercially available from TA).

The optical transmittance and b value were measured using an N&K spectrometer.

A degree of migration was measured with the naked eye.

### Examples 1 and 2

A resin composition obtained by uniformly mixing a UV absorbent with 100 parts by weight of a poly (N-cyclohexylmaleimide-co-methyl methacrylate-co-α-methyl-styrene) resin having a glass transition temperature of 120° C. according to the types and contents as listed in the following Table 1 was fed to a 24φ extruder in which a space spanning from a feed hopper to an extruder was replaced with nitrogen, and melted at 250° C. to prepare a feed pellet. The resin was analyzed using NMR. As a result, it was revealed that the content of N-cyclohexylmaleimide was 6.0% by weight, and the content of αmethyl-styrene was 2.0% by weight.

The feed pellet prepared thus was dried under a vacuum, melted at 250° C. in an extruder, and passed through a coat hanger-type T-die, followed by a chromium-plated casting roll and a drying roll, thereby manufacturing a film having a thickness of 200 μm.

The film was elongated twice at 130 to 135° C. in MD and TD directions using laboratory film elongation equipment to manufacture a biaxially elongated film having a thickness of 40 μm.

The optical transmittance at a wavelength of 380 nm and the b value of the film, and degrees of migration was measured during film formation were measured. The results are listed in the following Table 1.

Next, the film was exposed to light at a temperature of 60° C. and an energy density of 0.6 W/m² for 1,000 hours using UV2000 equipment (commercially available from Atlas), and then measured for optical transmittance and b value.

TABLE 1

| | | Content | | | | | |
|---|---|---|---|---|---|---|---|
| Type of | 1% Thermal | (part | % T @ | | % T @ 380 | b Value | |
| UV | decomposition | by | 380 | b | nm after | after | Degree of |
| absorbent | temperature | weight) | nm | Value | exposure | exposure | migration |
| Tinuvin | 344 | 2.5 | 3.32 | 0.4 | 3.35 | 0.4 | No change |
| 460 | | | | | | | in |
| | | | | | | | casting |
| | | | | | | | roll |
| | | 3 | 1.74 | 0.6 | 1.70 | 0.7 | No change |
| | | 4 | 0.49 | 0.8 | 0.51 | 0.9 | No change |
| LA F70 | 380 | 0.6 | 5.30 | 0.6 | 5.32 | 0.7 | No change |
| | | | | | | | in |
| | | | | | | | casting |
| | | | | | | | roll |
| | | 1 | 1.77 | 0.8 | 1.81 | 0.9 | No change |
| | | 2 | 0.02 | 1.0 | 0.03 | 1.1 | No change |

### Comparative Examples 1 and 2

Films were manufactured in the same manner as in Examples 1 and 2, except that UV absorbents listed in the following Table 2 were used as the UV absorbent. Thereafter, the optical transmittance at a wavelength of 380 nm and b values of the films, and degrees of migration were measured in the same manner as in Examples 1 and 2. The measurement results are listed in the following Table 2.

TABLE 2

| | 1% | | % T | | % T @ | b | |
|---|---|---|---|---|---|---|---|
| | Thermal | Content | @ | | 380 nm | Value | Degree |
| Type of UV | decomposition | (part by | 380 | b | after | after | of |
| absorbents | temperature | weight) | nm | Value | exposure | exposure | migrations |
| S-PA CK | 299 | 4.5 | 0.0 | 1.7 | 2.4 | 0.9 | Severe |
| | | | | | | | (casting |
| | | | | | | | roll is |
| | | | | | | | whitened) |
| | | 5 | 0.0 | 1.8 | 2.0 | 2.3 | Very |
| | | | | | | | severe |
| | | 6 | 0.0 | 2.1 | 1.5 | 2.8 | Very |
| | | | | | | | severe |
| UV3638 | 277 | 4.5 | 4.57 | 1.6 | 8.51 | 2.5 | Very |
| | | | | | | | severe |
| | | 5 | 3.32 | 1.9 | 6.67 | 3.1 | Very |
| | | | | | | | severe |
| | | 6 | 1.77 | 2.6 | 4.23 | 4.2 | Very |
| | | | | | | | severe |

As listed in Tables 1 and 2, it could be seen that there were no high changes in optical transmittance and b value after light exposure in the case of the optical films prepared in Examples 1 and 2 in which the thermal decomposition temperature of the UV absorbent was greater than or equal to 2.5 times the glass transition temperature (120° C.) of the acrylic resin, but there were high changes in optical transmittance and b value in the case of the optical films prepared in Comparative Examples 1 and 2. Also, it was revealed that the casting roll was hardly contaminated in the case of the optical films prepared in Examples 1 and 2, but was severely contaminated in the case of the optical films prepared in Comparative Examples 1 and 2.

1. An optical film comprising:
an acrylic resin having a glass transition temperature of 120° C. or higher and comprising an alkyl (meth)acrylate-based repeating unit and a styrene-based repeating unit; and
an UV absorbent having a 1% thermal decomposition temperature greater than or equal to a temperature 2.5 times that of the glass transition temperature of the acrylic resin.

2. The optical film of claim 1, wherein the acrylic resin further comprises at least one repeating unit selected from the group consisting of an imide-based repeating unit, a vinyl cyanide-based repeating unit, a 3- to 6-membered heterocyclic unit containing a functional group substituted with at least one carbonyl group, and a (meth)acrylate-based repeating unit having an aromatic ring.

3. The optical film of claim 1, wherein the UV absorbent is included in a content of 0.1 to 5 parts by weight, based on 100 parts by weight of the acrylic resin.

4. The optical film of claim 1, wherein the UV absorbent is a triazine-based UV absorbent.

5. The optical film of claim 4, wherein the UV absorbent has a 1% thermal decomposition temperature of 300° C. to 400° C.

6. The optical film of claim 1, wherein the optical film has optical transmittance at a wavelength of 380 nm of 5% or less, as measured after conversion into a thickness of 40 μm.

7. The optical film of claim 1, wherein the optical film has a variation in a b value of 0.5 or less, compared to an optical film which does not comprise the UV absorbent.

8. The optical film of claim 1, wherein the optical film has optical transmittance of 92% or more in a visual wavelength range.

9. A polarizing plate comprising at least one optical film defined in claim 1.

10. A display device comprising at least one optical film defined in claim 1.
